(19) United States
(12) Patent Application Publication
(10) Pub. No.: US 2003/0179249 A1
(43) Pub. Date: Sep. 25, 2003

(54) User interface for three-dimensional data sets

(76) Inventors: Frank Sauer, Princeton, NJ (US); James P. Williams, Princeton Junction, NJ (US); Ali Khamene, Plainsboro, NJ (US)

Correspondence Address: Siemens Corporation, Intellectual Property Department, 170 Wood Avenue South, Iselin, NJ, 08830, US

(21) Appl. No.: 10/365,194

(22) Filed: Feb. 12, 2003

Related U.S. Application Data
(60) Provisional application No. 60/356,191, filed on Feb. 12, 2002.
(60) Provisional application No. 60/356,190, filed on Feb. 12, 2002.

(51) Int. Cl. G09G 5/00

(52) U.S. Cl. 345/848

(57) ABSTRACT

A system and method for providing a user interface for three-dimensional data sets includes a processing unit, a tracking unit in signal communication with the processing unit, a registration unit in signal communication with the processing unit, and a display unit in signal communication with the processing unit; where the method includes receiving an image representation of a physical base, registering an image representation of a virtual object of interest relative to the physical base, and providing an image representation of an interface tool relative to the physical base.

### CROSS-REFERENCE TO RELATED APPLICATIONS

This application claims the benefit of U.S. Provisional Application Serial No. 60/356,191 (Attorney Docket No. 2002P02426US), filed Feb. 12, 2002 and entitled “Virtual Reality/Augmented Reality User Interface for Studying and Interacting with 3D Data Sets”, which is incorporated herein by reference in its entirety. This application further claims the benefit of U.S. Provisional Application Serial No. 60/356,190 (Attorney Docket No. 2002P02429US), filed Feb. 12, 2002 and entitled “Virtual Camera as Intuitive User Interface to 3D Data Display”, which is incorporated herein by reference in its entirety.

### BACKGROUND

The present disclosure relates to the visualization of 3D datasets and the user interaction with the display of these data sets. In particular, medical volume data such as computed tomography and magnetic resonance image data are addressed.

An exemplary application is the case where a surgeon would like to display 3D medical data for guidance in the operating room. It would be helpful if the surgeon could determine the viewpoint in an intuitive way, rather than having to rotate the image with a mouse or similar device.

Surgical navigation is commonly utilized by a surgeon or an interventional radiologist to guide instruments such as, for example, a biopsy needle, to a particular target inside a medical patient's body. The target is typically identified in one or more medical images, such as an image obtained by computerized tomography (“CT”), magnetic resonance imaging (“MRI”) or other appropriate techniques.

Navigation systems are available that comprise tracking systems to keep track of the positions of the instruments. These tracking systems are generally based either on optical or electromagnetic principles. Commercial optical tracking systems typically employ rigid multi-camera constellations. One popular type of commercial tracking system is that of stereo camera systems, such as, for example, the Polaris® from the Northern Digital company.

These tracking systems work essentially by locating markers in each camera image, and then calculating the marker locations in three-dimensional (“3D”) space by triangulation. For instrument tracking, “rigid body” marker sets with known geometric configurations are attached to the instruments. From the 3D marker locations, the system calculates the pose (i.e., rotation and translation) of the marker body with respect to a relevant coordinate system. Prior calibration and registration enable the system to derive the pose of the instrument from the pose of the marker body, and reference it to the patient's medical images. These procedures are commonly known to those of ordinary skill in the pertinent art.

### SUMMARY

These and other drawbacks and disadvantages of the prior art are addressed by a User Interface for Three-Dimensional Data Sets.

A system and corresponding method provide a user interface for three-dimensional data sets. The system includes a processing unit, a tracking unit in signal communication with the processing unit, a registration unit in signal communication with the processing unit, and a display unit in signal communication with the processing unit. The corresponding method includes receiving a real image representation of a physical base for tracking, registering an image representation of a virtual object of interest relative to the physical base, and providing an image representation of an interface tool relative to the physical base.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches a User Interface for Three-Dimensional Data Sets in accordance with the following exemplary figures, in which:

FIG. 1 shows a block diagram of a User Interface for Three-Dimensional Data Sets according to an illustrative embodiment of the present disclosure.

### DETAILED DESCRIPTION OF PREFERRED EMBODIMENTS

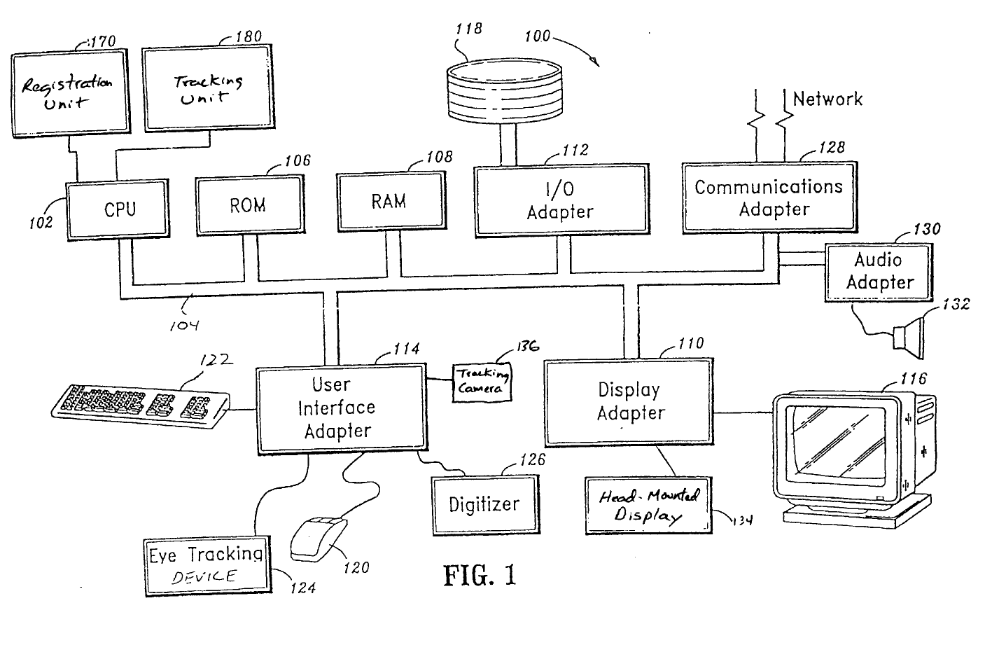

FIG. 1 shows a block diagram of a system 100 for providing a User Interface for Three-Dimensional (“3D”) Data Sets according to an illustrative embodiment of the present disclosure. The system 100 includes at least one processor or central processing unit (“CPU”) 102 in signal communication with a system bus 104. A read only memory (“ROM”) 106, a random access memory (“RAM”) 108, a display adapter 110, an I/O adapter 112, a user interface adapter 114, a communications adapter 128, and a video adapter 130 are also in signal communication with the system bus 104.

A display unit 116 is in signal communication with the system bus 104 via the display adapter 110. A disk storage unit 118, such as, for example, a magnetic or optical disk storage unit, is in signal communication with the system bus 104 via the I/O adapter 112. A mouse 120, a keyboard 122, and a head tracking device 124 are in signal communication with the system bus 104 via the user interface adapter 114. A video imaging device or camera 132 is in signal communication with the system bus 104 via the video adapter 130. A head-mounted display 134 is also in signal communication with the system bus 104 via the display adapter 110. A tracking camera 136, which may be physically attached to the head-mounted display 134, is in signal communication with the system bus 104 via the user interface adapter 114.

A registration unit 170 and a tracking unit 180 are also included in the system 100 and in signal communication with the CPU 102 and the system bus 104. While the units 170 and 180 are illustrated as coupled to the at least one processor or CPU 102, these components are preferably embodied in computer program code stored in at least one of the memories 106, 108 and 118, wherein the computer program code is executed by the CPU 102.

As will be recognized by those of ordinary skill in the pertinent art based on the teachings herein, alternate embodiments are possible, such as, for example, embodying some or all of the computer program code in registers located on the processor chip 102. Given the teachings of the disclosure provided herein, those of ordinary skill in the pertinent art will contemplate various alternate configurations and implementations of the optimization unit 170 and the registration unit 180, as well as the other elements of the system 100, while practicing within the scope and spirit of the present disclosure.

In operation, a user observes the 3D structures with a stereoscopic head-mounted display 134. The virtual 3D structures are linked to a physical structure, herein called the base, which can be placed on the table before the user or picked up and moved around by hand. As the 3D graphics appears attached to the physical structure, the user can inspect the 3D structure by moving his head and/or by moving the physical base. Hence, the user inspects the virtual 3D structure in an intuitive way, similar to inspecting a corresponding real structure. The virtual structure under investigation is called the virtual object of interest.

For interaction with the virtual structures, the user is provided with interface tools. Preferably, these are handheld physical objects simply called tools. Tools are visualized as corresponding virtual tools in the virtual scene. The user can employ virtual tools to outline structures in the 3D graphics, select and deselect features, define and move multiplanar reconstruction (“MPR”) planes, and like operations.

The function of a virtual tool is depicted in its graphical representation. For a different function, the user can either pick up a different physical tool, or he can change the functionality of the current physical tool by associating it with a different virtual tool.

For the case where the user is a surgeon who uses the display of 3D medical data for guidance in an operating room, embodiments of the present disclosure are helpful in that they permit the surgeon to determine the viewpoint in an intuitive way, rather than having to rotate the image with a mouse or similar device. In the present disclosure, the term “viewpoint” shall be defined to mean the pose of the viewing system including, for example, the viewing axis, as represented by the exterior orientatation of the camera or viewer. An exemplary embodiment of the present disclosure describes a “virtual camera” as a handheld instrument that the surgeon points towards the patient from a desired viewpoint. The position of this instrument is tracked and transmitted to the computer that now renders the 3D image from the instrument's viewpoint. The instrument acts like a virtual camera. The image rendered is the virtual view that the virtual camera has of the 3D data set. The 3D data set is approximately registered with the real patient. Hence, the user can intuitively map the displayed view onto the patient and understand the anatomy. This method can be useful not only for image guidance during surgery, but also for training where a student can explore the virtual anatomy of a dummy.

An exemplary embodiment system includes a display means 134 or 116, computing means 102 with graphics rendering means 110, tracking means 124, and user interface means 114. The preferred display means is a stereoscopic head-mounted display 134. For the computing means 102, a standard personal computer (“PC”) can be used, preferably with a fast graphics card. If volume rendering is desired, preferably a graphics card with hardware support for volume rendering should be used.

For tracking, optical tracking means 124 are preferred because of their precision and minimal time delay. The system tracks the base and the tools in use with respect to the user's head or viewpoint. A particularly preferred embodiment fixes a wide-angle tracking camera 136 on the head-mounted display (“HMD”) 134, tracking optical markers attached to the base and tools.

The user interfaces with the system by means of the base and the tools, which are mechanical structures that are equipped with markers and/or sensors for the purpose of being tracked by the tracking means. The movement of base and tools, as tracked by the tracking means, is translated by the computing means into a corresponding movement of associated graphical structures, a virtual object of interest and virtual tools, respectively, in the displayed virtual 3D scene. Base and tools can include conventional electric interfaces like buttons, wheels, trackballs and the like connected to the computing means via wires or wireless communication. The function of such interfaces can also be implemented in a virtual way, where the user touches corresponding graphical objects in the virtual world with a virtual tool to trigger an action. User interaction may involve both hands simultaneously.

The system is initially calibrated so that the movement of the virtual objects as seen by the user registers well with the actual movement of the base and tools. This can be done according to methods known to those of ordinary skill in the pertinent art.

A virtual camera is a stylus-like or pointer-like instrument. The system 100 includes a means for tracking the virtual camera, an input means for triggering the update of the view according to the virtual camera's position, and a method to initially register the data set to the patient or dummy, at least in an approximate way.

For tracking, commercial tracking systems are available based on magnetic, inertial, acoustic, or optical methods. An update switch is provided since a user may want to press a switch to update the viewpoint. This switch may be implemented simply by an electrical contact switch connected to the computer by an electrical wire. The switch can also be implemented in a wireless way with a transmitter in the virtual camera and a corresponding receiver connected to the computer. The switch can also be implemented by optical signals, such as, for example, when the tracking is performed with optical means. Continuous updating is technically more challenging and not necessarily more useful.

Image registration is also performed by the system 100. If there are visible landmarks that also appear in the data set, the user may touch these landmarks with the tracked virtual camera to determine their coordinates in a world coordinate system. The data set can then be registered to the patient using the point correspondences between world coordinates and image coordinates. This is a standard procedure for commercial image guidance systems. However, the virtual camera user interface does not require high registration accuracy. Another, simpler method for approximate registration includes pointing the camera in outlining the extent and position of the data set with respect to the patient. For example, in the case where the data set is a head scan, the user can simply record the top of the head, the chin or nose position, and the axis of the head so that the system can make an approximate registration. The registration is guided by the system with corresponding responses via the update switch, or there may be additional switches on the instrument to trigger the data collection for the registration.

Embodiments of the present disclosure significantly differ from commercial image guidance systems (“IGS”), which are generally expensive high precision systems used to map instrument position accurately into data set. The Virtual Camera embodiment of the present disclosure, in contrast, is an inexpensive user interface that helps the user to select desired viewpoints of 3D images in an intuitive way with mental mapping of data onto patient, but facilitated by intuitive understanding of the chosen displayed viewpoints.

Various variations and alternate embodiments of the present disclosure are possible. For example, a stereo monitor such as an auto-stereoscopic monitor or a standard monitor in conjunction with Crystal Eye stereo glasses may be used instead of the stereoscopic HMD. Alternately, a monitor in conjunction with a mirror or semitransparent mirror may be substituted.

In embodiments of the present disclosure, a user's viewpoint is tracked and the virtual objects are rendered accordingly such that the user can inspect the object from different sides by moving his or her head. The stereoscopic HMD can have opaque displays where the user sees only the displayed image, or semitransparent displays where the user can look through the displays and get a glimpse of the real scene behind the displays.

The HMD can also be of the video-see-through type, where two video cameras are attached to the HMD and serve as artificial eyes. In this case, the user is provided with a stereoscopic augmented video image of the scene, where graphics is blended with the live video images.

External tracking cameras may be used instead of the head-mounted tracking camera. Magnetic tracking means may be used instead of optical tracking means, or combination of both; or other tracking means such as tracking based on ultrasound time-of-flight measurements, inertial tracking, and the like.

Wireless connection between tools and/or base with the computing means to transmit trigger signals such as the pushing of a button may be used. Trigger functions may also be implemented via tracking means. In case of optical tracking, for example, covering or uncovering an optical marker or switching a light source on or off for an active optical marker can be detected by the tracking system and communicated to the computing means to trigger a specified action.

The system can also be used for the inspection of 4D data sets, such as, for example, a time sequence of 3D data sets. The setup preferably has a tabletop format such that the user sits at a table where he or she can pick up the physical base and the interface tools. The system can preferably accommodate more than one user simultaneously such that two or more users can inspect the same virtual structures sitting next to each other.

In addition, several system embodiments of the present disclosure can be linked together so that two or more users can inspect the same virtual structure from remote locations. Voice transmission between the users can be added for this case.

These and other features and advantages of the present disclosure may be readily ascertained by one of ordinary skill in the pertinent art based on the teachings herein. It is to be understood that the teachings of the present disclosure may be implemented in various forms of hardware, software, firmware, special purpose processors, or combinations thereof.

Most preferably, the teachings of the present disclosure are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. All such changes and modifications are intended to be included within the scope of the present disclosure as set forth in the appended claims.

What is claimed is:

1. An intuitive user interface for representing three-dimensional (“3D”) data from a user viewpoint, the interface comprising:
a computer having a graphics rendering engine;
a stereoscopic display in signal communication with the computer for displaying the 3D data as a rendered virtual object;
a physical base disposed relative to the stereoscopic display for defining a location of the virtual object;
an instrument in signal communication with the computer for interacting with the virtual object; and
a tracking device in signal communication with the computer for tracking the relative poses of the physical base, instrument and user viewpoint.

2. An intuitive user interface as defined in claim 1 wherein the stereoscopic display comprises a binocular display.

3. An intuitive user interface as defined in claim 2 wherein the binocular display comprises a head-mounted stereoscopic display.

4. An intuitive user interface as defined in claim 3 wherein the head-mounted stereoscopic display is of the video-see-through variety.

5. An intuitive user interface as defined in claim 1 wherein the tracking device comprises an optical tracking device in signal communication with the computer.

6. An intuitive user interface as defined in claim 5 wherein the optical tracking device comprises a head-mounted tracking camera.

7. An intuitive user interface as defined in claim 1 wherein the instrument comprises a switch in signal communication with the computer.

8. An intuitive user interface as defined in claim 1 wherein the instrument comprises at least one of a trackball and a thumbwheel in signal communication with the computer.

9. An intuitive user interface as defined in claim 8 wherein the signal communication is wireless.

10. An intuitive user interface as defined in claim 1 wherein the physical base comprises a switch in signal communication with the computer.

11. An intuitive user interface as defined in claim 1 wherein the physical base comprises at least one of a trackball and a thumbwheel in signal communication with the computer.

12. An intuitive user interface as defined in claim 11 wherein the signal communication is wireless.

13. An intuitive user interface as defined in claim 1 wherein the 3D data comprises 3D medical images.

14. A method for representing a virtual object from a user viewpoint, the method comprising:
providing a user viewpoint;
defining a pose of a virtual object relative to a physical base;
providing an instrument for interacting with the virtual object;
tracking the relative poses of the physical base, instrument and user viewpoint;
rendering three-dimensional (“3D”) data indicative of the virtual object and the instrument in accordance with the defined and tracked poses; and
stereoscopically displaying the rendered virtual object.

15. A method as defined in claim 14, further comprising placing and moving multiplanar reconstruction (“MPR”) planes for interacting with the virtual object.

16. A method as defined in claim 14, further comprising outlining structures in the 3D data for interaction with the virtual object.

17. A method as defined in claim 14, further comprising switching between different functionalities of the instrument.

18. A method as defined in claim 17, further comprising visualizing the instrument as a virtual instrument in a pose linked to its tracked pose.

19. A method as defined in claim 18, further comprising rendering the virtual instrument with a different appearance in accordance with its selected functionality.

20. A program storage device readable by machine, tangibly embodying a program of instructions executable by the machine to perform program steps for representing a virtual object from a user viewpoint, the program steps comprising:
providing a user viewpoint;
defining a pose of a virtual object relative to a physical base;
providing an instrument for interacting with the virtual object;
tracking the relative poses of the physical base, instrument and user viewpoint;
rendering three-dimensional (“3D”) data indicative of the virtual object and the instrument in accordance with the defined and tracked poses; and
stereoscopically displaying the rendered virtual object.

21. A virtual camera interface for intuitively selecting the orientation of a three-dimensional (“3D”) data set to be rendered as an image, the interface comprising:
a computer having a graphics engine for rendering an image from a 3D data set;
a display device in signal communication with the computer for displaying the rendered image from the 3D data set;
a handheld instrument in signal communication with the computer for selecting an orientation; and
a tracking device in signal communication with the computer for tracking the position of the instrument to determine the orientation.

22. A virtual camera interface as defined in claim 1 wherein the 3D data set comprises a 3D image of a real object.

23. A virtual camera interface as defined in claim 22 wherein the real object is a person.

24. A virtual camera interface as defined in claim 22 wherein the 3D data set comprises a 3D medical image.

25. A virtual camera interface as defined in claim 22 wherein the 3D image is approximately registered to the real object.

26. A virtual camera interface as defined in claim 25 wherein the orientation for rendering the 3D image is approximately equal to the orientation of the handheld instrument with respect to the real object.

27. A virtual camera interface as defined in claim 21 wherein the handheld instrument comprises a switch in signal communication with the computer for updating the rendering of the image according to the orientation by means of triggering the switch.

28. A virtual camera interface as defined in claim 21 wherein the tracking device comprises a tracking camera.

29. A virtual camera interface as defined in claim 21 wherein the handheld instrument comprises at least one optical marker.

30. A method for intuitively selecting the orientation of a three-dimensional (“3D”) data set to be rendered as an image, the method comprising:
selecting a orientation for an image from a 3D dataset in correspondence with a handheld instrument;
rendering the image from the 3D data set in accordance with the selected orientation;
displaying the rendered image from the 3D data set on a display device; and
tracking the position of the handheld instrument to maintain the orientation.

31. A method as defined in claim 30 wherein the 3D data set comprises a 3D image of a real object.

32. A method as defined in claim 31 wherein the real object is a person.

33. A method as defined in claim 31 wherein the 3D data set comprises a 3D medical image.

34. A method as defined in claim 31 wherein the 3D image is approximately registered to the real object.

35. A method as defined in claim 34, further comprising rendering the image from a orientation approximately equal to the orientation of the handheld instrument with respect to the real object.

36. A method as defined in claim 30, further comprising updating the rendering of the image in accordance with the orientation by detecting a triggering event of the handheld instrument.

37. A method as defined in claim 30, further comprising tracking the position of the handheld instrument with a tracking camera.

38. A method as defined in claim 30, further comprising tracking the handheld instrument by means of at least one optical marker.

39. A program storage device readable by machine, tangibly embodying a program of instructions executable by the machine to perform program steps for intuitively selecting the orientation of a three-dimensional (“3”) data set to be rendered as an image, the program steps comprising:
selecting a orientation for an image from a 3D dataset in correspondence with a handheld instrument;
rendering the image from the 3D data set in accordance with the selected orientation;
displaying the rendered image from the 3D data set on a display device; and
tracking the position of the handheld instrument to determine the orientation.

40. A virtual camera interface for intuitively selecting the orientation of a three-dimensional (“3D”) data set to be rendered as an image, the interface comprising:
instrument means for selecting a orientation for an image from a 3D dataset;
computing means for rendering the image from the 3D data set in accordance with the selected orientation;
display means for displaying the rendered image from the 3D data set; and
tracking means for tracking the position of the instrument means to determine the orientation.
